(19) United States
(12) Patent Application Publication
(10) Pub. No.: US 2004/0163883 A1
(43) Pub. Date: Aug. 26, 2004

(54) Electroacoustic transducer

(75) Inventor: Katsutoshi Suzuki, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/780,992

(22) Filed: Feb. 18, 2004

(30) Foreign Application Priority Data
Feb. 24, 2003 (JP) 2003-046460

(51) Int. Cl. H04R 7/00; G10K 13/00; H04R 1/00; H04R 11/02; H04R 9/06

(52) U.S. Cl. 181/173; 181/171

(57) ABSTRACT

The present invention is directed to an electroacoustic transducer, which is capable of controlling a particular vibration mode having large amplitude generated in a diaphragm and reproducing and outputting with fidelity a sound signal transmitted to the diaphragm. A vibration-generating driving source 3 is supported on the back side of a diaphragm 2 near one end of the diaphragm 2 of the electroacoustic transducer 1, at least one end 2a and the two sides 2b and 2b perpendicular to the one end 2a and opposite to each other are supported on an elastic cushion member 9, the cushion member 9 is supported on a base 10, with one side of the base 10 supporting the diaphragm 2 and the other side of the base 10 arranged at a side opposite to the diaphragm 2, and a vibration controlling portion 9a and 30a for controlling a particular vibration mode having a large amplitude generated in the diaphragm 2 is formed in the cushion member 9 or the base 10, and wherein the diaphragm 2 vibrates in a plane direction perpendicular to the plane of the diaphragm 2 when the vibration-generating driving source 3 is driven.

### BACKGROUND OF THE INVENTION

1. Field of the Invention

The present invention relates to an electroacoustic transducer, and more particularly to a thin-type electroacoustic transducer using a plane diaphragm and an electronic apparatus using the electroacoustic transducer.

2. Description of the Related Art

There have been thin-type electroacoustic transducers conventionally employed as speakers or microphones for a variety of electronic apparatuses such as notebook-type personal computers, thin-type televisions or portable telephones.

Such conventional electroacoustic transducers are provided with a plane diaphragm 51, and a vibration-generating driving source 52 for vibrating the diaphragm 51 is arranged at the back side of the diaphragm 51, as shown in FIG. 6.

The vibration-generating driving source 52 is provided with a magnet 53 fixed to a base 55 via a first yoke 54. In addition, the first yoke 54 is provided with a pair of arms 54b and 54b extending by a predetermined length from both ends of a base 54a toward the diaphragm 51.

In addition, the base 54a is fixed to the base 55, and the magnet 53 is fixed to the base 54a between the pair of arms 54b and 54b.

In addition, a second yoke 56 is fixed to the magnet 53 at a side opposite to the back side of the diaphragm 51, and a predetermined gap is formed between the second yoke 56 and the back side of the diaphragm 51. In addition, a coil 57 is fixed to the back side of the diaphragm 51, and the entire circumference of the outer peripheral end of the diaphragm 51 is supported on a cushion member 58 whose bottom is mounted on the base 55.

In cases where the conventional electroacoustic transducer as described above is a speaker, when an alternating current, being an electrical signal converted from a sound signal, flows into the coil 57, the coil 57 operates with the magnetic field of the magnet 53 and vibrates in a plane direction perpendicular to the plane of the diaphragm 51, according to Fleming's rule. In synchronization with this vibration of the coil 57, the diaphragm 51 supported on the cushion member 58 vibrates in the plane direction shown by an arrow A with a predetermined frequency, thereby making it possible to output a sound of a predetermined volume.

In addition, the ideal frequency characteristic by which a natural sound is reproducible is preferably a vibration mode as flat as possible, such as an F mode, as shown in FIG. 7, in which the entire diaphragm 51 integrally vibrates.

However, in the conventional electroacoustic transducer, there is a case in which the frequency characteristic of the diaphragm 51 vibrates in a particular vibration mode having large unevenness, such as a B mode or a C mode, for example, as shown in FIG. 7.

When the diaphragm 51 vibrates in the particular vibration mode having large unevenness, such as a B mode or a C mode, if the electroacoustic transducer is a speaker, for example, the sound signal cannot be reproduced with fidelity, and, accordingly, there is a fear that a reproduced sound will be a unnatural sound.

### SUMMARY OF THE INVENTION

In consideration of the above problem, it is an object of the present invention to provide an electroacoustic transducer, which is capable of controlling unevenness of a particular vibration mode having a large uneven frequency characteristic of a diaphragm.

As first means to achieve the above object, an electroacoustic transducer according to the present invention comprises a plane diaphragm and a vibration-generating driving source for vibrating the diaphragm, wherein the vibration-generating driving source is supported on the back side of the diaphragm near one end of the diaphragm, at least the one end and the two sides perpendicular to the one end and opposite to each other are supported on an elastic cushion member, the cushion member is supported on a base, with one side of the base supporting the diaphragm and the other side of the base arranged at a side opposite to the diaphragm, and a vibration controlling portion for controlling a particular vibration mode having a large amplitude generated in the diaphragm is formed in the cushion member or the base, and wherein the diaphragm vibrates in a plane direction perpendicular to the plane of the diaphragm when the vibration-generating driving source is driven.

As second means to achieve the above object, the vibration controlling portion is formed by partly varying the width dimension of at least a portion of the cushion member supporting the two opposite sides of the diaphragm, and the elastic force of the cushion member supporting the diaphragm is partly varied by the vibration controlling portion.

As third means to achieve the above object, the vibration controlling portion is formed by partly varying the width dimension of the cushion member by partly projecting or concaving the portion of the cushion member supporting the diaphragm.

As fourth means to achieve the above object, the vibration controlling portion comprises holes formed in a portion of the cushion member, and the elastic force of the cushion member supporting the diaphragm is partly varied by the holes.

As fifth means to achieve the above object, the vibration controlling portion comprises a stepped portion formed in the portion of the base supporting the other side of the cushion member, and the elastic force of the cushion member supporting the diaphragm is partly varied by the stepped portion.

As sixth means to achieve the above object, the vibration-generating driving source includes a magnet arranged with a predetermined gap between the magnet and the back side of the diaphragm, and a coil wound with a predetermined gap between the coil and the outer peripheral surface of the magnet, the coil being fixed to the back side of the diaphragm, the magnet being mounted on a first plate-shaped yoke, and wherein the first yoke is supported on a connecting member fixed to the back side of the diaphragm and a gap is formed between the first yoke and the base.

### BRIEF DESCRIPTION OF THE DRAWINGS

FIG. 1 is a view illustrating a first embodiment according to the present invention;

FIG. 2 is a view illustrating a first embodiment according to the present invention;

FIG. 3 is a view illustrating a first embodiment according to the present invention;

FIG. 4 is a view illustrating a second embodiment according to the present invention;

FIG. 5 is a view illustrating a third embodiment according to the present invention;

FIG. 6 is a sectional view for main portions illustrating a conventional electroacoustic transducer; and

FIG. 7 is a graph illustrating a vibration mode of a diaphragm of an electroacoustic transducer.

### DESCRIPTION OF THE PREFERRED EMBODIMENTS

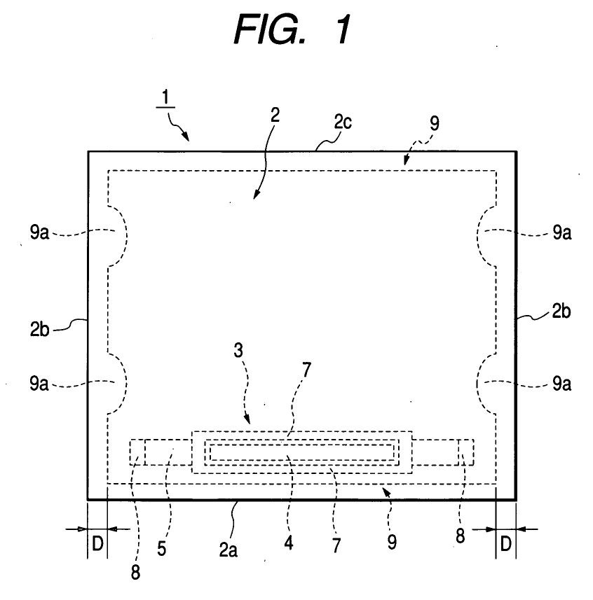

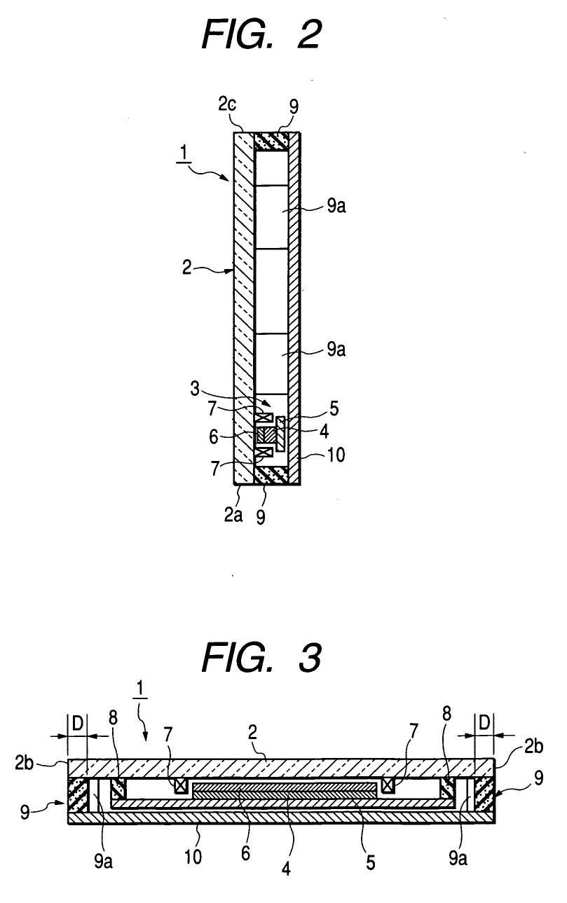

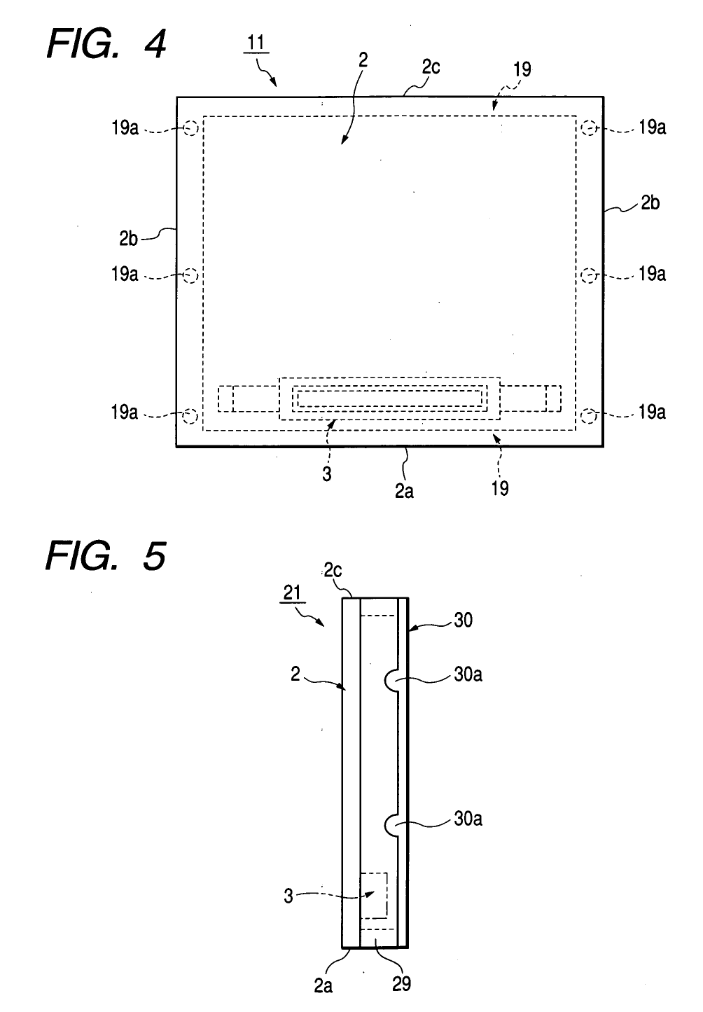

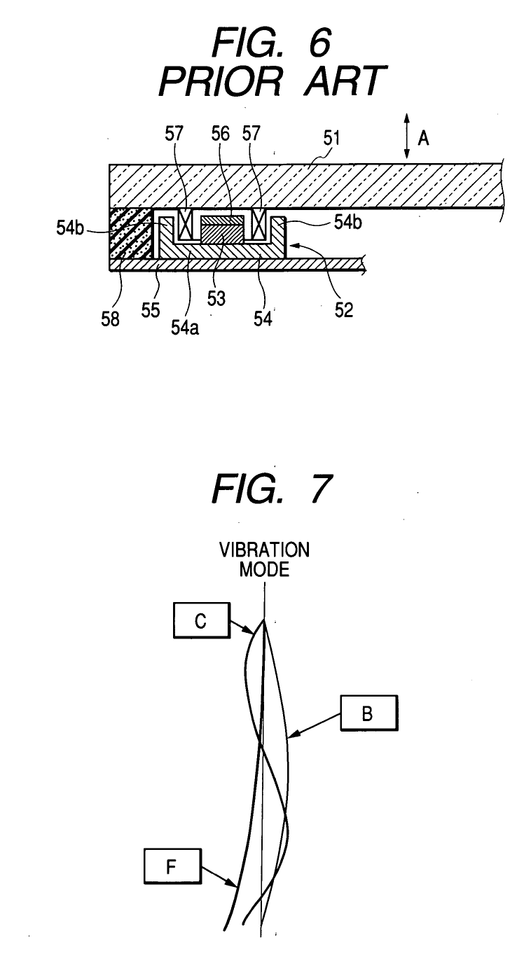

Now, embodiments of an electroacoustic transducer according to the present invention will be described with reference to FIGS. 1 to 5. FIGS. 1 to 3 are views illustrating a first embodiment according to the present invention. FIG. 4 is a view illustrating a second embodiment according to the present invention. FIG. 5 is a view illustrating a third embodiment according to the present invention.

First, as shown in FIGS. 1 to 3, an electroacoustic transducer 1 according to a first embodiment of the present invention is provided at its uppermost portion with a diaphragm 2 made of a transparent acryl plate or the like. The diaphragm 2 is formed of a nearly rectangular shape by one end 2a in the front side of the figure, two sides 2b and 2b opposite to each other and perpendicular to the one end 2a, and the other end 2c opposite to the one end 2a.

A vibration-generating driving source 3 for vibrating the diaphragm 2 is arranged at the back side of the diaphragm 2, in the vicinity of its one end 2a. The vibration-generating driving source 3 is provided with a magnet 4 consisting of a permanent magnet with a predetermined gap between the magnet 4 and the back side of the diaphragm 2. The magnet 4 is formed of a horizontally long shape in parallel to the one end 2a of the diaphragm 2.

In addition, the magnet 4 is mounted on a nearly central portion of a first plate-shaped yoke 5 of a horizontally long shape longer than the magnet 4 and is fixed by means of an adhesive or the like.

In addition, a second plate-shaped yoke 6, formed of the same size as the magnet 4 at a side opposite to the back side of the diaphragm 2, is fixed to the magnet 4, and a predetermined gap is formed between the second yoke 6 and the back side of the diaphragm 2.

In addition, the vibration-generating driving source 3 is provided with a coil 7 wound with a predetermined gap between the coil 7 and the outer peripheral surfaces of the magnet 4 and the second yoke 6. The coil 7 is fixed to the back side of the diaphragm 2 by means of an adhesive or the like.

In addition, the first yoke 5 mounting and fixing the magnet 4 is supported on a connecting member 8 formed longer than the horizontally long coil 7 and whose both ends extending outwardly beyond the longitudinal direction of the coil 7 are fixed to the back side of the diaphragm 2.

In other words, the magnet 4 is mounted on the first plate-shaped yoke 5 supported on a pair of connecting members 8 and 8 fixed to the back side of the diaphragm 2, and is arranged at a side opposite to the back side of the diaphragm 2, with the second yoke 6 interposed therebetween. The connecting member 8 is made of the same material as a cushion member 9, for example, which will be described later.

In addition, a gap between the inner peripheral surface of the coil 7 and the outer peripheral surfaces of the magnet 4 and the second yoke 6 is formed to be nearly 0.2 mm, for example, and a predetermined gap is formed between the bottom of the coil 7 and the first yoke 5, as shown in FIG. 3.

In addition, the entire circumference of the outer peripheral end at the back side of the diaphragm 2, with an outer diameter of a rectangular shape, is supported on a cushion member 9 made of an elastic polyurethane foaming agent or the like.

The cushion member 9 is provided with a vibration controlling portion 9a consisting of convexes formed by projecting portions supporting the two opposite sides 2b and 2b of the diaphragm 2 in the direction opposite to each other.

In addition, the elastic force of the cushion member 9 is partly varied by the vibration controlling portion 9a consisting of the convexes.

By making the frequency characteristic of the diaphragm 2 as flat as possible, a particular vibration mode, such as an F mode, shown in FIG. 7, where the entire diaphragm 2 integrally vibrates, can be controlled.

In addition, the vibration controlling portion 9a is not limited to convexes and but may consist of concaves (not shown)., and the width dimension D of the cushion member 9 may partly vary.

In addition, the cushion member 9 is supported on a plate-shaped base 10, with one side of the base 10 supporting the diaphragm 2 and the other side of the base 10 arranged at a side opposite to the diaphragm 2.

In the electroacoustic transducer 1 according to the first embodiment of the present invention constructed as above, when the vibration-generating driving source 3 is driven, the diaphragm 2 vibrates in the plane direction perpendicular to the plane of the diaphragm 2.

In addition, in the electroacoustic transducer 1 according to the first embodiment, by forming the vibration controlling portion 9a by partly varying the width dimension of the cushion member 9 such that a large unevenness (belly portion), such as a B mode or a C mode, which is a particular mode generated in the diaphragm 2, as described in the conventional technique, can be suppressed, the frequency characteristic of the diaphragm 2 becomes as flat as possible so that it can approach the F mode, as shown in FIG. 7, which shows the ideal vibration frequency characteristic by which the entire diaphragm 2 integrally vibrates.

In other words, in the electroacoustic transducer 1 according to the present invention, the vibration controlling portion 9a for controlling a particular vibration mode generated in the diaphragm 2 is formed.

Although the vibration controlling portion 9a formed in the cushion member 9 in the portions supporting the two opposite sides 2b and 2b has been explained, the vibration controlling portion 9a may be formed in the cushion member 9 supporting one end 2a or the other end 2c of the diaphragm 2.

In other words, the vibration controlling portion 9a may be formed by partly varying the width dimension of the cushion member 9 supporting at least two opposite sides 2b and 2b of the diaphragm 2.

In addition, although, in the vibration controlling portion 9a, the width dimension D of the cushion member 9 being partly varied by projecting a portion of the cushion member 9, has been explained, the width dimension D of the cushion member 9 may be varied by making a portion of the cushion member 9 concave.

In other words, the vibration controlling portion 9a may be formed by partly varying the width dimension of the cushion member 9 by partly projecting or concaving the portion of the cushion member 9 supporting the diaphragm 2.

In addition, in the electroacoustic transducer 11 according to a second embodiment of the present invention, as shown in FIG. 4, a plurality of holes, which function as the vibration controlling portion 19a, is formed in part of the cushion member 19. The elastic force of the cushion member 19 near the vibration controlling portion 19a is smaller than the elastic force at the portion where the vibration controlling portion 19a is not formed.

In other words, in the second embodiment of the present invention, the elastic force of the cushion member 19 supporting the diaphragm 2 is partly varied by the vibration controlling portion 19a consisting of the plurality of holes.

In addition, in the electroacoustic transducer 21 according to a third embodiment of the present invention, as shown in FIG. 5, a stepped portion consisting of convexes is formed as the vibration controlling portion 30a at a portion of a side of a base 30 supporting a cushion member 29.

Here, the cushion member 29 has no vibration controlling portions 9a and 19a described in the first and second embodiments, and therefore, can be easily made.

In addition, when the other side of the cushion member 29 is pushed and fixed to the base 30 by means of an adhesive or the like, the portion positioned in the vibration controlling portion 30a consisting of the stepped portion is elastically deformed so that the elastic force of the cushion member 29 partly varies.

The vibration controlling portion 30a consisting of the stepped portion is not limited to convexes, but may consist of concaves (not shown).

As described above, in the electroacoustic transducers 11 and 21 according to the second and third embodiments, the elastic forces of the cushion members 19 and 29 supporting the diaphragm 2 can be partly varied by the respective vibration controlling portions 19a and 30a.

For this reason, in the second and third embodiments, the unevenness (belly portion) of the B mode or the C mode, which is a particular vibration mode having a large unevenness generated in the diaphragm 2 can be suppressed, as in the first embodiment.

In addition, the vibration frequency characteristic of the diaphragm 2 can approach the F mode, which is the ideal vibration frequency characteristic.

As described above, since the cushion member or the base of the electroacoustic transducer of the present invention is provided with a vibration controlling portion for controlling a particular vibration mode generated in the diaphragm, when the vibration-generating driving source is driven, the diaphragm vibrates in the plane direction perpendicular to the plane of the diaphragm, and thus the unevenness (belly portion) of a particular vibration mode having a large unevenness generated in the diaphragm can be suppressed by the vibration controlling portion, thereby making it possible to approach the ideal vibration frequency characteristic.

For this reason, an electroacoustic transducer with high precision, which is capable of reproducing a sound with fidelity in response to a sound signal from the diaphragm, can be provided.

In addition, since the vibration controlling portion is formed by partly varying the width dimension of the cushion member at the portion supporting at least the two opposite sides of the diaphragm, and the elastic force of the cushion member supporting the diaphragm is partly varied by the vibration controlling portion, the unevenness (belly portion) of a particular vibration mode generated in the diaphragm can be suppressed by the vibration controlling portion.

In addition, since the vibration controlling portion is formed by partly varying the width dimension of the cushion member by partly projecting or concaving the portion of the cushion member supporting the diaphragm, a particular vibration mode generated in the diaphragm can be reliably controlled and the portion corresponding to the belly portion having a large amplitude can be suppressed.

In addition, since the vibration controlling portion comprises holes formed in a portion of the cushion member and the elastic force of the cushion member supporting the diaphragm is partly varied by the holes, a particular vibration mode generated in the diaphragm can be controlled by a simpler structure.

In addition, since the vibration controlling portion comprises a stepped portion formed in the portion of the base supporting the other side of the cushion member, and the elastic force of the cushion member supporting the diaphragm is partly varied by the stepped portion, the elastic force of the cushion member can be partly varied by the stepped portion formed in the base, without forming unevenness or holes in the cushion member having bad processability due to elastic force.

In addition, since the coil of the vibration-generating driving source is fixed to the back side of the diaphragm, a magnet is mounted on the first plate-shaped yoke, which is supported on the connecting member fixed to the back side of the diaphragm, and a gap is formed between the first yoke and the base, a high-performance electroacoustic transducer having a vibration-generating driving source for reliably vibrating the diaphragm can be provided.

What is claimed is:

1. An electroacoustic transducer comprising:
a plane diaphragm and
a vibration-generating driving source for vibrating the diaphragm,
wherein the vibration-generating driving source is supported on the back side of the diaphragm near one end of the diaphragm, at least the one end and the two sides perpendicular to the one end and opposite to each other are supported on an elastic cushion member, the cushion member is supported on a base, with one side of the base supporting the diaphragm and the other side of the base arranged at a side opposite to the diaphragm, and a vibration controlling portion for controlling a particular vibration mode having a large amplitude generated in the diaphragm is formed in the cushion member or the base, and wherein the diaphragm vibrates in a plane direction perpendicular to the plane of the diaphragm when the vibration-generating driving source is driven.

2. The electroacoustic transducer according to claim 1,
wherein the vibration controlling portion is formed by partly varying the width dimension of at least a portion of the cushion member supporting the two opposite sides of the diaphragm, and the elastic force of the cushion member supporting the diaphragm is partly varied by the vibration controlling portion.

3. The electroacoustic transducer according to claim 2,
wherein the vibration controlling portion is formed by partly varying the width dimension of the cushion member by partly projecting or concaving the portion of the cushion member supporting the diaphragm.

4. The electroacoustic transducer according to claim 1,
wherein the vibration controlling portion comprises holes formed in a portion of the cushion member, and the elastic force of the cushion member supporting the diaphragm is partly varied by the holes.

5. The electroacoustic transducer according to claim 1,
wherein the vibration controlling portion comprises a stepped portion formed in the portion of the base supporting the other side of the cushion member, and the elastic force of the cushion member supporting the diaphragm is partly varied by the stepped portion.

6. The electroacoustic transducer according to claim 1,
wherein the vibration-generating driving source includes a magnet arranged with a predetermined gap between the magnet and the back side of the diaphragm, and a coil wound with a predetermined gap between the coil and the outer peripheral surface of the magnet, the coil being fixed to the back side of the diaphragm, the magnet being mounted on a first plate-shaped yoke, and
wherein the first yoke is supported on a connecting member fixed to the back side of the diaphragm and a gap is formed between the first yoke and the base.
